(19) United States
(12) Patent Application Publication
(10) Pub. No.: US 2015/0199322 A1
(43) Pub. Date: Jul. 16, 2015

(54) Operating Method of Terminal for Proofreading Electronic Document

(71) Applicant: Min Kyu Kim, Seoul (KR)

(72) Inventors: Min Kyu Kim, Seoul (KR); Jung Woo Lee, Seoul (KR)

(73) Assignee: Min Kyu Kim, Seoul (KR)

(21) Appl. No.: 14/195,545

(22) Filed: Mar. 3, 2014

(30) Foreign Application Priority Data
Jan. 15, 2014 (KR) 10-2014-0004979

(51) Int. Cl. G06F 17/24; G06F 3/0486; G06F 3/0484

(52) U.S. Cl. CPC G06F 17/241; G06F 17/24; G06F 3/04842; G06F 3/0486

(57) ABSTRACT

An operating method of a terminal is disclosed. The operating method of a terminal includes displaying an original document as an correction object, setting an edit mode for editing the original document, receiving selection of text included in the original document from a user, displaying a space for editing the selected text; receiving input of text in the space, and editing the selected text, using the input text.

### CROSS REFERENCE TO RELATED APPLICATION

This application claims priority from and the benefit of Korean Patent Application No. 10-2014-0004979, filed on Jan. 15, 2014, which is hereby incorporated by reference for all purposes as if fully set forth herein.

### BACKGROUND OF THE DISCLOSURE

1. Field of the Disclosure

Exemplary embodiments of the disclosure relate to an operating method of a terminal for proofreading a document, more particularly, to an operation of a terminal which enables a writer of an electronic document to recognize reviewer's proofreading for the electronic document intuitionally.

2. Discussion of the Background

With supply of electronic document processors (or word processors), works via electronic documents are of greater importance than works via printed documents. The printed documents have an advantage that they can be recognized more intuitionally than the electronic documents. Accordingly, there are increasing demands for electronic documents to have the advantage of the printed documents.

In this connection, Korean Patent No. 2002-008294 discloses a browser exclusively for education, with a real-time proofreading function. In the published patent, means for inputting proofread contents according to the prior art may be a mouse, an electronic pen, digitizer and the like. While an education class is in progress, lecture contents are displayed on a monitor possessed by a student and the teacher's voice is output via a speaker simultaneously. In a state where education contents are displayed on the learner's monitor during the lecture, instructor can operate system to display cursor, draw underline, or change the color of a specific portion provided in a document may be changed which is a characteristic of the patent application mentioned above.

However, the prior art fails to reflect the intuitiveness possessed by the printed document to the electronic document. Accordingly, technology enabling a writer of an electronic document to recognize proofreading of a reviewer more intuitionally is required.

### SUMMARY OF THE DISCLOSURE

Exemplary embodiments of the present disclosure provide intuitive method for proofreading an electronic document through an analog and digital proofreading style.

Exemplary embodiments of the present disclosure also provide a method of sharing an electronic document with a third person.

Exemplary embodiments of the present disclosure also provide a displaying method of an original version and a proofread version of an electronic document selectively.

Additional features of the present disclosure will be set forth in the description which follows, and in part will be apparent from the description, or may be learned by practice of the disclosed subject matter.

Exemplary embodiments of the present disclosure disclose an operating method of a terminal including displaying an original document as an proofreading object; setting an edit mode for editing the original document; receiving selection of one or more words (referred to as text hereinafter) included in the original document from a user; displaying a space for editing the selected text; receiving input text in the space; and editing the selected text, using the input text.

The proofreading of the selected text, using the input text, may include displaying a strikethrough on original text that is not matched after comparing the input text and the selected text; and displaying corresponding text out of the input text above the original text with the strikethrough.

In case the input text is to change a singular form included in the selected text into a plural form, editing the selected text, using the input text, may include adding different style applied alphabet(s) of “s”, “es” or “ies” after the selected text.

In case the input text is to add additional letters after the selected text, editing the selected text, using the input text, may include adding different style applied additional letters after the selected text.

In case the input text is to remove three or less letters before or after the selected text, editing the selected text, using the input text, may display a partial strikethrough on the original text where the letters are removed from the input texttext.

In case the input text is to change a lowercase alphabet letter of the first letter in the selected text into an uppercase alphabet letter or to change an uppercase alphabet letter of the first letter in the selected text into a lowercase alphabet letter, editing the selected text, using the input text, may include changing a lowercase alphabet letter included in the selected text into a different style applied uppercase alphabet letter from the selected text or to change an uppercase alphabet letter included in the selected text into a different style applied lowercase alphabet letter from the selected text.

In case the input text is to add one or more new words to the selected text, editing the selected text, using the input text, may include adding new text having a different style applied thereto to the selected text.

In case the selected text are empty space between words, editing the selected text, using the input text may include inserting the input text having a different style applied thereto from the selected text in the space.

The operating method of the terminal may further include setting the mode into a annotation mode for adding an annotation to the original document; receiving selection of text included in the original document from the user in the annotation mode; applying a mark indicating an annotated area to the selected text; generating a space for inputting the comment; inputting a comment in the space; and connecting the input comment with the mark indicating the annotated area.

In case the annotation mode is an annotation mode for adding an annotation on a word, the mark indicating the annotated area may be a circle around the selected text, and in case the annotation mode is an annotation mode for adding an annotation on a sentence, the mark indicating the annotated area may be an underline of all or some of one or more sentences including the selected text, and in case the annotation mode is an annotation mode for adding an annotation on a paragraph, the mark indicating the annotated area may be an arc displayed next to one or more paragraphs including the selected text.

The mark indicating the annotated area may include a circle, an underline or an arc next to a paragraph, and the mark indicating the annotated area may be connected with the input comment by a line in the connecting the input comment with the mark indicating the annotated area.

The operating method of the terminal may further include detecting a drag for the input comment; and moving the input comment along the drag.

The operating method of the terminal may further include setting the mode into a record mode for adding voice recording to the original document; receiving selection of text included in the original document from the user in the voice recording mode; inputting voice recording for the selected text; applying a mark indicating a voice recording applied area to the selected text; and connecting voice recording data for the input voice recording to the mark indicating the voice recording applied area.

The operating method of the terminal may further include setting the mode into a share mode for sharing a proofread document including input text or an edited document including the corrected text; giving unique URL (Uniform Resource Locator) to the original document, the proofread document or the edited document in the share mode; and sending the unique URL to a second terminal distinguished from the terminal.

The operating method of the terminal further includes displaying text input by a plurality of users simultaneously, in case a plurality of users proofread the original document.

The operating method of the terminal may further include displaying a plurality of proofread documents created by a plurality of users, in case a plurality of users proofread the original document.

According to the exemplary embodiments of the disclosure, the proofreading method for an electronic document may be recognizable intuitionally through an analog and digital proofreading style.

Furthermore, the electronic document may be shared with a third person.

Still further, the original version and the proofread version of an electronic document may be displayed selectively.

It is to be understood that both the foregoing general description and the following detailed description are exemplary and explanatory and are intended to provide further explanation of the disclosed subject matter as claimed.

### BRIEF DESCRIPTION OF THE DRAWINGS

The accompanying drawings, which are included to provide a further understanding of the disclosed subject matter and are incorporated in and constitute a part of this specification, illustrate exemplary embodiments of the disclosed subject matter, and together with the description serve to explain the principles of the disclosed subject matter.

FIG. 1 is a flow chart illustrating an operating method of a terminal for proofreading an electronic document;

FIG. 2 is a flow chart illustrating an operating method of a terminal in a proofreading mode;

FIG. 3 is a diagram illustrating an analog proofreading process;

FIG. 4 is a diagram illustrating a digital proofreading process;

FIG. 5 is a flow chart illustrating an operating method of a terminal in an annotation mode; and

FIG. 6 is a diagram illustrating annotations on words, sentences and paragraphs.

### DETAILED DESCRIPTION OF THE ILLUSTRATED EMBODIMENTS

Exemplary embodiments of the disclosed subject matter are described more fully hereinafter with reference to the accompanying drawings. The disclosed subject matter may, however, be embodied in many different forms and should not be construed as limited to the exemplary embodiments set forth herein. Rather, the exemplary embodiments are provided so that this disclosure is thorough and complete, and will convey the scope of the disclosed subject matter to those skilled in the art. In the drawings, the size and relative sizes of layers and regions may be exaggerated for clarity. Like reference numerals in the drawings denote like elements.

It will be understood that when an element or layer is referred to as being “on”, “connected to”, or “coupled to” another element or layer, it can be directly on, connected, or coupled to the other element or layer or intervening elements or layers may be present. In contrast, when an element is referred to as being “directly on”, “directly connected to”, or “directly coupled to” another element or layer, there are no intervening elements or layers present. As used herein, the term “and/or” includes any and all combinations of one or more of the associated listed items. It may also be understood that for the purposes of this disclosure, “at least one of X, Y, and Z” can be construed as X only, Y only, Z only, or any combination of two or more items X, Y, and Z (e.g., XYZ, XYY, YZ, ZZ).

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the present disclosure.

The terminology used herein is for the purpose of describing exemplary embodiments only and is not intended to be limiting of the disclosed subject matter. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the disclosed subject matter are described herein with reference to cross-section illustrations that are schematic illustrations of idealized embodiments (and intermediate structures) of the disclosed subject matter. As such, variations from the shapes of the illustrations as a result, for example, of manufacturing techniques and/or tolerances, are to be expected. Thus, exemplary embodiments of the disclosed subject matter should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the disclosed subject matter will be described in detail with reference to the accompanying drawings.

A terminal for proofreading an electronic document according to exemplary embodiments of the disclosure may a device for processing an electronic document which includes an input unit, an output unit, a storage unit, a processing unit and a communication unit. Examples of the terminal may include PC, a mobile terminal, a tablet PC, a notebook and PDA.

The electronic document may be an electronic document which can be processed in a terminal. The electronic document may include one or more characters, symbols, figures, mathematic formulas, forms and pictures. In the embodiments of the disclosure, an original document, a proofread document and an edited document are electronic documents.

The original document means a document first read by a terminal and the proofread document means a document having proofreading displayed therefore. The proofreading means proofreading of a word included in the original document or annotations on a word, a sentence or a paragraph included in the original document. The proofread document includes a proofreading process or annotations by a reviewer. The edited document means a document having all of the proofreading for the original document applied thereto. The edited document may include no proofreading process or annotations made by the reviewer.

The terminal may provide an interface for proofreading an electronic document. The interface may include a button for loading the original document, a button for setting an operating mode of the terminal into an edit mode configured to edit the original document, a button for setting an annotation mode configured to add annotations to the original document, a button for sharing a document with a second terminal distinguished from the terminal and a button for sending the original document, the proofread document or the edited document.

Moreover, the interface may include a button for displaying the original document, the proofread document or the edited document selectively. For instance, when the button for displaying the original document is selected, the terminal may display the original document. When the button for displaying the proofread document, the terminal may display the edited document.

When a plurality of users proofread the original document, there may be a plurality of proofread documents and the interface may include a button for displaying the plurality of the proofread documents proofread by the plurality of the users selectively. For instance, when there are a first proofread document proofread by a first user and a second proofread document proofread by a second user, the interface may include a button for displaying a first proofread document and a button for displaying a second proofread document.

The terminal may display the first proofread document and the second proofread document in one document. Specifically, the terminal may display the corrections of the first proofread document and the second proofread document in the original document simultaneously. The interface may include a button for displaying the first and second proofread documents in one document.

Also, the terminal may provide a button for implementing a function of allowing a plurality of users in communication for editing a document through the interface to exchange text messages through a chat window.

The button may be displayed as various objects which can be provided for selection.

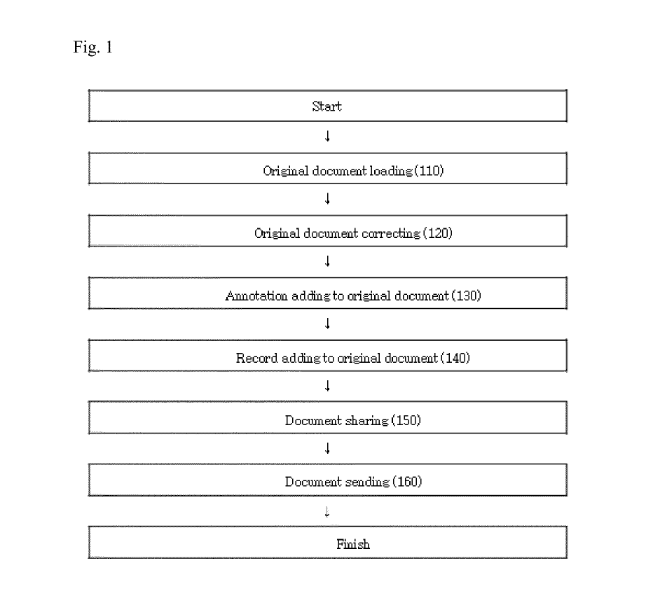

FIG. 1 is a flow chart illustrating an operating method of a terminal for proofreading an electronic document.

Referring to FIG. 1, the terminal loads an original document in a step (110). The original document may be stored locally or a web. A user may select an original document in a local or web through an explorer for exploring locally or a web and select the original document in the web. After that, the terminal may load the selected original document. Alternatively, the terminal may load the original document through the user's drag & drop. The user may drag and drop the original document to an interface provided for correction of an electronic document by the terminal and the terminal may load a corresponding original document. The terminal may display the loaded original document on a screen thereof.

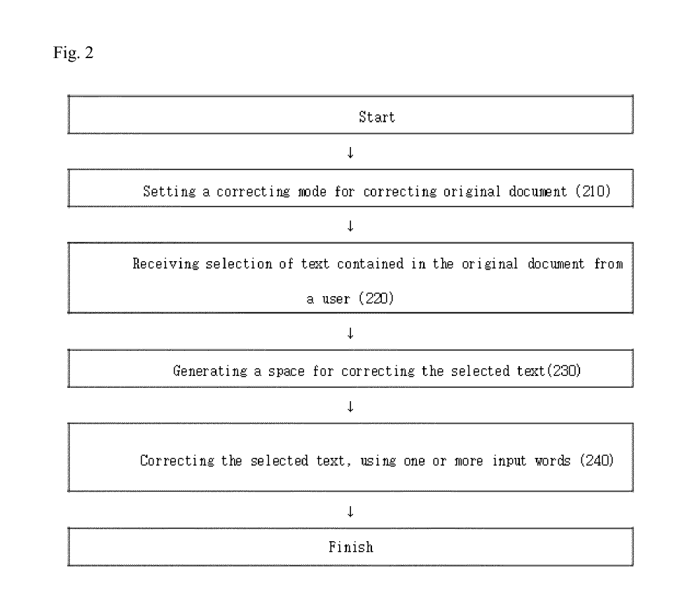

In a step (120), the terminal proofreads the original document. The terminal may set an operating mode into an edit mode for editing the original document and receive selection of text included in the original document from the user. After that, the terminal may display a space for editing the selected text and allow input text to the space, only to edit the selected text, using the input text. Editing of the document may be performed in an analog form and a digital form. The step 120 will be described in detail, referring to FIG. 2.

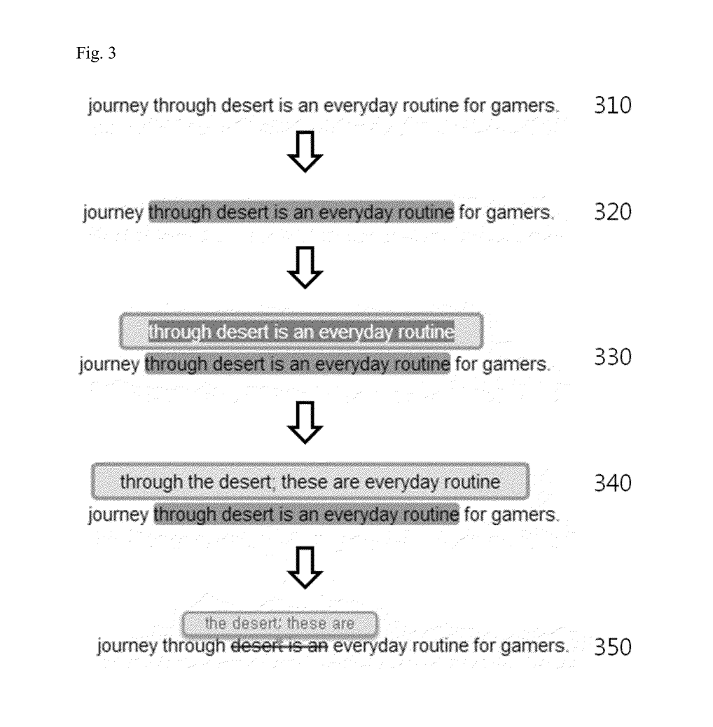

In a step (130), the terminal may add annotations to the original document and set an operating mode into an annotation mode for adding annotations to the original document. In the annotation mode, the terminal may receive selection of text included in the original document from the user and apply a mark indicating an area where annotations are applied to the selected text. Also, the terminal may generate a space for receiving input of comments and receive comments in the space. After that, the terminal may connect the input comments with the mark indicating that the words are the area where the annotations are applied. The step 130 will be described in detail, referring to FIG. 3.

In a step (140), the terminal adds recording to the original document the recording may means a voice comment on the original document. The terminal may set an operation mode into a record mode for adding record to the original document. In the record mode, the terminal may allow the user to select text included in the original document and receive an input of voice recording for the selected text. After that, the terminal applies a mark to the selected text and the mark indicating an area where the voice recording is applied. The terminal may connect the input voice recording with the mark indicating an area where the recoding is applied.

The terminal may provide a user interface with a button for receiving an input of voice recording from the user. When detecting the user's input to the button, the terminal may generate recording data having a voice comment. The user interface may also include a button for playing or storing the voice recording.

In a step (150), the terminal may share documents with a second terminal distinguished from the terminal. The terminal may set an operating mode into a share mode configured to share the original document, the proofread document or the edited document.

In the share mode, the terminal may give unique URL (Uniform Resource Locator) to the original document, the proofread document or the edited document. The unique URL may be generated through a service server and it may be configurated as six random numbers. The terminal may give the unique URL generated through the service server to each of the documents. The URL may allow the original document, the proofread document or the edited document to be managed on a web.

The unique URL may be transmitted to a second terminal distinguished from the terminal and the second terminal may display the original document, the proofread document or the edited document or implement re-correction, using the unique URL.

The second terminal may be a SNS (Social Network Service) server. In this instance, the second terminal may upload the original document, the proofread document or the edited document to a specific page, using the received unique URL. An interface for proofreading an electronic document may include a button for uploading the original document, the proofread document or the edited document to the specific page.

In a step (160), the terminal may send the document and it may send the original document, the proofread document and the edited document. When the original document is proofread by the plurality of the users, the terminal may send each of the proofread documents. An interface for proofreading the electronic document may include a button for selecting a document to send from the original, proofread and edited documents.

The document may be generated in a form readable in another word processor by the sending operation or in another word processor form to allow the sent document readable by another word processor.

FIG. 2 is a flow chart illustrating an operating method of a terminal in an edit mode.

Referring to FIG. 2, in a step (210), the terminal may set an operation mode into an edit mode for editing an original document. The terminal may set the operating mode into the edit mode, in response to an input to a button for setting an edit mode of an interface so as to proofread an electronic document. The terminal may perform operations of steps 220 through 240 in the edit mode repeatedly.

In a step (220), the terminal receives selection of text included in the original document from the user. The terminal may select a word unit of the text included in the original document based on the user's selection. For instance, when the user selects “nt from real li” from a character string of “Distant from real life” included in the original document, the terminal may apply a mark indicating a selected area to “from real”. The terminal applies proofreading to a marked portion and the proofreading is performed by a word unit. The word unit proofreading has a high intuitive effect, compared with character unit or sentence unit proofreading.

In a step (230), the terminal generates a space for editing the selected text. The space may include the selected words.

In a step (240), the terminal may edit the selected text, using the input text. The edited text may be displayed with an analog or digital proofreading style.

For the analog proofreading style, strikethrough is marked in the selected text for editing and the edited text is displayed above the selected text. The reason why the edited word is displayed above the word marked for editing is that a higher intuitional effect can be achieved in comparison with the edited words displayed next to or below the word marked for editing.

For the digital proofreading style, the input text is added to or replaces the selected text in a state where a gap between two words is kept.

In case a singular expression is changed into a plural form in English or an English uppercase letter is changed into an English lowercase letter or a new word is added between words, the digital proofreading style is applied. In the other cases, the analog proofreading style is applied.

Specifically, in case a current case belongs to no cases corresponding to the digital proofreading style as shown in FIG. 3, the terminal may display strikethrough on original text not matching with the input text out of the selected text shown in “350” of FIG. 3 and display text corresponding to the original text with the strikethrough above the original text with the strikethrough, out of the input text.

When the input text are to add additional words after the selected text, the terminal may add additional letters having a different style from the selected text after the selected text. The style may include a character shape, a character color, an effect, a size and a style. The effect may include an underline, a strikethrough, a shadow and an outline. The style may include an italic type and a bold face style.

In case the input text is to remove three or less characters before or after the selected text, the terminal may display a partial strikethrough on the original text where the letters are removed from the input texttext.

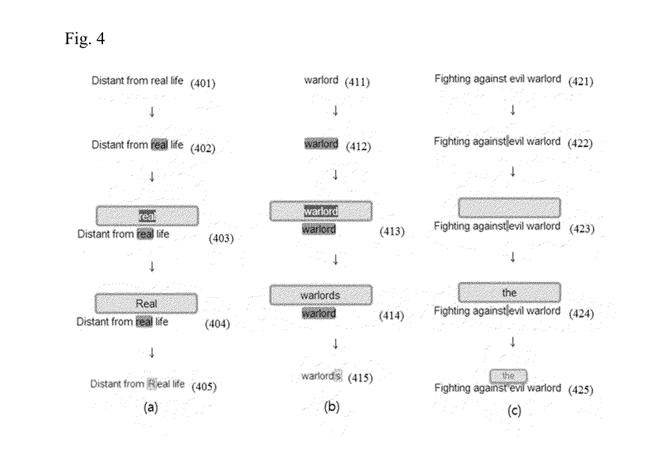

In case the input text are to change an English singular form included in the selected text into a plural form as shown in FIG. 4 (a), the terminal may add alphabets of “s”, “es” or “ies” having a different style applied thereto after the selected text as shown in “415” of FIG. 4.

In case the input text are to change a lowercase letter of the selected text into an uppercase letter or an uppercase letter of the first one of the selected text into a lowercase letter as shown in FIG. 4 (a), the terminal may change a lowercase letter included in the selected text into an uppercase letter having a different style applied thereto or change an uppercase letter included in the selected text into a lowercase letter having a different style applied thereto as shown in FIG. “405” of FIG. 4.

In case the selected one or words are empty space between words as shown in FIG. 4 (c), the terminal may insert the input text having a different style applied thereto in the space as shown in “425” of FIG. 4.

In case the input or more words are to add new text to the selected text, the terminal may add a new text to the selected text in a different style from the selected text.

A writer of the original document may intuitionally recognize a reviewer's correction through the analog and the digital proofreading style.

When the corrected text are selected, the interface for proofreading the electronic document may provide a button for deleting the analog or the digital proofreading style.

FIG. 3 is a diagram illustrating an analog proofreading process.

Referring to FIG. 3, the analog proofreading process may include text 310 provided in an original document, selected text 320, a space 330 for editing the selected text, input text 340 and edited text 350. The space 330 may include selected text 320.

When the input text 340 are corresponding to only some of the selected text 320, the terminal may display a strikethrough on the corresponding portion of the selected text 320.

For instance, when “is an” is deleted from “through desert is an everyday routine” shown in FIG. 3 to add “the” and “these are”, strikethrough is displayed on “desert is an” related to the deletion and addition and “the desert: these are” corresponding to the input text may be displayed above “desert is an” having the strikethrough.

When a plurality of users edit the original document, the terminal may display text input by a plurality of users simultaneously. For instance, when there are plural edited expressions for “through desert is an everyday routine”, all of the plural expressions may be displayed above “desert is an” having the strikethrough. The interface for proofreading the electronic document may provide a button for displaying the text input by the plurality of the users simultaneously.

FIG. 4 is a diagram illustrating a digital proofreading process.

Referring to FIG. 4, there are (a) of a digital proofreading process in case of changing a lowercase alphabet letter into an uppercase alphabet letter and vice versa, (b) a digital proofreading process in case of changing a singular form into a plural form, (c) a digital proofreading process in case of adding a new word.

For each case, there are shown text 401, 411 and 421 included in the original document, selected text 402, 412 and 422, spaces 403, 413 and 423 for editing the selected one or more words, input text 404, 414 and 424 and edited text 405, 415 and 425.

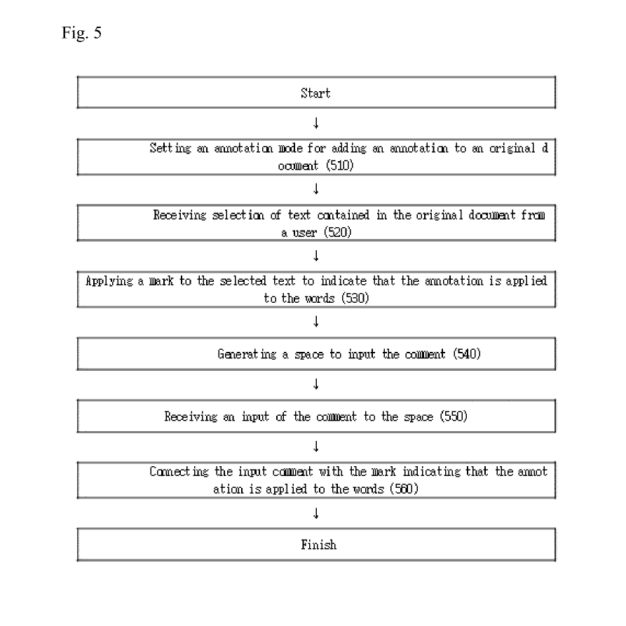

FIG. 5 is a flow chart illustrating an operating method of the terminal in an annotation mode.

Referring to FIG. 5, in a step (510), the terminal sets an annotation mode for adding an annotation to the original document. The terminal may set an operating mode into an annotation mode in response to an input to a button provided to set an annotation mode by an interface for proofreading an electronic document. The terminal may implement operations of steps 510 through 560 repeatedly.

The annotation mode may include an annotation mode for adding an annotation on a word, an annotation mode for adding an annotation on a sentence and an annotation mode for adding an annotation on a paragraph.

In a step (520), the terminal may receive selection of text included in an original document from the user. The terminal may select the text included in the original document by a word unit according to the user's selection.

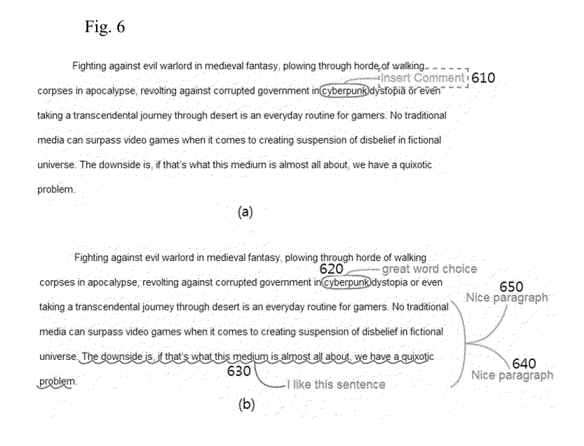

In a step (530), the terminal applies a mark indicating an annotated area to the selected text. An embodiment of the mark indicating the annotated area is shown in FIG. 6.

The mark indicating the annotated area may be configured of a circle, an underline or an arc next to a paragraph. The mark indicating the annotated area may be connected with the comment by a line. Examples of the line may include a colored line, a straight line, a solid line and a dotted line.

For instance, in the annotation mode for adding an annotation to a word, a mark indicating an annotated area may be a circle for the selected text shown in “620) of FIG. 6.

In the annotation mode for adding an annotation on a sentence, the mark indicating the annotated area may be an underline for all or a part of one or more sentences including the selected text shown in “630” of FIG. 6.

In the annotation mode for adding an annotation to a paragraph, the mark indicating the annotated area may be an arc displayed next to one or more paragraphs including the selected text shown in “640” and “650” of FIG. 6.

In a step (540), the terminal may generate a space for inputting an annotation. The space for inputting the comment may include text, symbols or figures indicating an annotation input space. An embodiment of the space for inputting the comment is shown in “610” of FIG. 6 and the space for inputting the comment can be moved by the user's drag & drop.

In a step (550), the terminal receives the comment in the space and an embodiment of the comment input is shown in FIG. 6 (b). The input comment can be moved by the user's drag & drop. For instance, the comment displayed in “640” of FIG. 6 can be moved to “650” of FIG. 6 by the user's drag.

In a step (560), the terminal connects the input comment with a mark indicating the annotated area. For instance, the terminal may connect the input comment shown in FIG. 6 with the mark indicating the annotated area, using a solid line. When the space for inputting the comment or the input comment is moved, the solid line may be also moved to a proper position for the input comment or for indicating or annotated area.

FIG. 6 is a diagram illustrating an annotation on a word, a sentence and a paragraph.

Referring to FIG. 6, there are shown a case (a) of selecting a word for inputting an annotation and a screen displayed (b) in case the word is selected. There are shown a space 610 for inputting an annotation, a mark 620 indicating an annotated area in an annotation mode for adding an annotation on a word, a mark 630 indicating an annotated area in an annotation for adding an annotation on a sentence, and a mark 640 and 650 indicating an annotated area in an annotation mode for adding an annotation on a paragraph. The input comment may be moved by the user's drag. For instance, an annotation displayed on “640” of FIG. 6 can be moved to “650” of FIG. 6 by the user's drag.

The embodiments mentioned hereinabove may be realized by a computing unit including a processor, a memory, a display and a user interface.

The methods according to the exemplary embodiments of the disclosure may be realized into program instructions which can be implemented by various types of computer systems and stored in computer readable medium.

The method according to the embodiments may be realized as program instruction implemented by various computer means and recorded in a computer readable medium. The computer readable medium may include a program command, a data file, a data structure or combination of them. The program command recorded in the medium may be configured for exemplary embodiments of the disclosure. Examples of computer readable medium include magnetic medium such as a hard disk, a floppy disk, optical medium such as CD-ROM and DVD, magneto-optical medium such as a floptical disk, and a hardware device such as ROM, RAM, and a flash memory. The hardware device may be configured to execute one or more software modules to implement the exemplary embodiments. The software may include a computer program, a code, an algorithm, an instruction, and any combination thereof. The software may include a mechanical language code made by a compiler and a high level language code implementable by a computer, using an interpreter, and the like. The software may be dispersed on a computer system or through a network. The software and data may be stored or implemented in one or more computer readable recording medium.

It will be apparent to those skilled in the art that various modifications and variations can be made in the present disclosure without departing from the spirit or scope of the disclosed subject matter. Thus, it is intended that the present disclosure cover the modifications and variations of the disclosed subject matter provided they come within the scope of the appended claims and their equivalents.

What is claimed is:

1. An operating method of a terminal comprising:
displaying an original document as a proofreading object;
setting an edit mode for editing the original document;
receiving selection of text included in the original document from a user;
displaying a space for editing the selected text;
receiving input of text in the space; and
editing the selected text, using the input text.

2. The operating method of the terminal of claim 1, wherein the correcting of the selected text, using the input text, comprises:
displaying a strikethrough on original text that is not matched after comparing the input text and the selected text; and
displaying corresponding text out of the input text above the original text with the strikethrough.

3. The operating method of the terminal of claim 1, wherein in case the input text is to change a singular form included in the selected text into a plural form, editing the selected text, using the input text, comprises,
adding different style applied letters of “s”, “es” or “ies” after the selected text.

4. The operating method of the terminal of claim 1, wherein in case the input text is to add additional letters after the selected text, editing the selected text, using the input text, comprises:
adding different style applied additional letters after the selected text.

5. The operating method of the terminal of claim 1, wherein in case the input text is to remove three or less letters before or after the selected text, editing the selected text, using the input text, comprises:
displaying a partial strikethrough on the original text where the letters are removed from the input text.

6. The operating method of the terminal of claim 1, wherein in case the input text is to change a lowercase letter of the first letter in the selected text into an uppercase letter or to change an uppercase letter of the first letter in the selected text into a lowercase letter, editing the selected text, using the input text, comprises:
changing a lowercase letter included in the selected text into a different style applied uppercase letter from the selected text or to change an uppercase letter included in the selected text into a different style applied lowercase letter from the selected text.

7. The operating method of the terminal of claim 1, wherein in case the input text are to add new text to the selected text, editing the selected text, using the input text, comprises:
adding new text having a different style applied thereto to the selected text.

8. The operating method of the terminal of claim 1, wherein in case the selected text are empty space between words, editing the selected text, using the input text, comprises:
inserting the input text having a different style applied thereto from the selected text in the space.

9. The operating method of the terminal of claim 1, further comprising:
setting the mode into an annotation mode for adding an annotation to the original document;
receiving selection of text included in the original document from the user in the annotation mode;
applying a mark indicating an annotated area to the selected text;
generating a space for inputting the comment;
inputting a comment in the space; and
connecting the input comment with the mark indicating the annotated area.

10. The operating method of the terminal of claim 9, wherein in case the annotation mode is an annotation mode for adding an annotation on a word, the mark indicating the annotated area is a circle around the selected text, and
in case the annotation mode is an annotation mode for adding an annotation on a sentence, the mark indicating the annotated area is an underline of all or some of one or more sentences including the selected text, and
in case the annotation mode is an annotation mode for adding an annotation on a paragraph, the mark indicating the annotated area is an arc displayed next to one or more paragraphs including the selected text.

11. The operating method of the terminal of claim 9, wherein the mark indicating the annotated area comprises a circle, an underline or an arc, and
the mark indicating the annotated area is connected with the input comment by a line in the connecting the input comment with the mark indicating the annotated area.

12. The operating method of the terminal of claim 9, further comprising:
detecting a drag for the input comment; and
moving the input comment along the drag.

13. The operating method of the terminal of claim 1, further comprising:
setting the mode into a voice recording mode for adding voice recording to the original document;
receiving selection of text included in the original document from the user in the voice recording mode;
inputting voice recording for the selected text;
applying a mark indicating a voice recording applied area to the selected text; and
connecting voice recording data for the input recording to the mark indicating the voice recording applied area.

14. The operating method of the terminal of claim 1, further comprising:
setting the mode into a share mode for sharing an proofread document including input text or an edited document including the corrected text;
giving unique URL (Uniform Resource Locator) to the original document, the proofread document or the edited document in the share mode; and
sending the unique URL to a second terminal distinguished from the terminal.

15. The operating method of the terminal of claim 1, further comprising:
displaying text input by a plurality of users simultaneously, in case a plurality of users proofread the original document.

16. The operating method of the terminal of claim 1, further comprising:
displaying a plurality of proofread documents proofread by a plurality of users, in case a plurality of users proofread the original document.
